(19) United States
(12) Patent Application Publication
(10) Pub. No.: US 2017/0099394 A1
(43) Pub. Date: Apr. 6, 2017

(54) ALLOCATING EXPENSE OF DATA TRANSFERS BETWEEN PARTICIPANTS

(71) Applicant: PAYPAL, INC., San Jose, CA (US)

(72) Inventor: Todd Murray Studnicka, Omaha, NE (US)

(21) Appl. No.: 14/876,452

(22) Filed: Oct. 6, 2015

(51) Int. Cl. H04M 15/00; H04L 12/14; H04M 15/10

(52) U.S. Cl. CPC H04M 15/8214; H04M 15/72; H04M 15/10; H04M 15/781; H04L 12/1435; H04M 15/8033; H04M 15/8038

(57) ABSTRACT

There are provided systems and methods for allocating expense of data transfers between participants. An initiating endpoint may request to establish a voice data transfer with a receiving endpoint. A payment provider may receive data transfer information associated with the voice data transfer, which may include identifiers for the endpoints or users for their respective endpoints, as well as information used to determine a cost associated with the voice data transfer. The data transfer may also be a text or other data transfer. The payment provider may determine an endpoint initially assigned responsibility for payment of the voice data transfer by a service provider. The payment provider may receive a request from the endpoint initially responsible for payment to allocate at least a portion of the cost to the other endpoint. If the request is accepted, the payment provider may provide payment to the service provider or between the endpoints.

### TECHNICAL FIELD

The present application generally relates to data transfers and more specifically to allocation of expense responsibility when a voice or text data transfer is initiated by a particular voice or text data endpoint.

### BACKGROUND

Various types of voice or text data transfers may be conducted between voice or text data endpoints. For example, modem technology allows for telephonic voice or data data transfers between participants using a Public Switched Telephone Network (PSTN), SMS services, or may utilize data transferred over a computer network, such as Voice over IP (VoIP), Voice over LTE VoLTE), or other types of data transfer services. During use of these data transfer services, cost is allocated to one party, typically, the initiator of the data transfer. While “collect call” type services exist to allow the initiator to request that the receiver accept responsibility, such services are limited to assigning responsibility to one party. Moreover, these services require establishment after initiation of the data transfer and prior to completion of the connection between the parties. Thus, data transfer participant endpoints are limited by current technology in their ability to allocate responsibility for the data transfer.

### BRIEF DESCRIPTION OF THE DRAWINGS

FIG. 1 is a block diagram of a networked system suitable for implementing the processes described herein, according to an embodiment;

FIG. 2 is exemplary interfaces of a voice data endpoint during a voice data transfer and used for allocation of expenses, according to an embodiment;

FIG. 3 is an exemplary system environment showing voice data endpoints during a voice data transfer and additional service providers for initiation of the voice data transfer and allocation of expenses, according to an embodiment;

FIG. 4 is a flowchart of an exemplary process for allocating expense of voice data transfers between participants, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for allocating expense of voice data transfers between participants. Systems suitable for practicing methods of the present disclosure are also provided.

A user may initiate a voice data transfer with another user using a voice data endpoint, such as a mobile device, telephone system device, network capable computing device, or other type of device. Similarly, the receiving user may receive the request to initiate the voice data transfer and may engage in the voice data transfer through a similar endpoint device. In typical Public Switched Telephone Networks (PSTNs), the initiating user may be responsible for payment of the voice data transfer (e.g., telephone call), for example, using a billable plan, minutes within a pre-paid or monthly allocated plan, and/or payment at the time of call initiation. In various types of telephone calls, the receiving user may also be partially or wholly responsible for payment of the voice data transfer, for example, where a “collect call” is placed to the receiving user. Moreover, other types of technology may utilize similar payment responsibility, such as VoIP, VoLTE, or other types of data transfers. Payments may be made to a service provider that provides the voice data transfer capabilities to the endpoints, such as a telephone service provider (e.g., Verizon®, AT&T®, Cox Communications®, local or state telephone agencies, etc.) or other types of data transfer service providers (e.g., Skype®, Cisco®, etc.). The users may establish accounts with these service providers, which may be pre-paid, billable, and/or monthly/yearly/etc.

In order to provide allocation of expenses for a voice data transfer different than the prearranged payment responsibility set by the service providers, a payment service provider may be utilize to receive data transfer information for the voice data transfer. The data transfer information may include data indicating initiation and/or establishment of the voice data transfer. Moreover, the data transfer information may include identifiers that allow the payment provider to identify the initiating user/endpoint and the receiving user/endpoint. For example, an identifier for the initiating user may include a name, account name, token, and/or device identifier for the user and/or endpoint device. Similarly, the identifier used to identify the receiving user/endpoint may include similar data within the data transfer information. The data transfer information may further include data that identifies the user/endpoint responsible for payment of the voice data transfer. Thus, the data transfer information may allow the payment provider to identify if the initiating user/endpoint, receiving user/endpoint, and/or a split of both users/endpoints is responsible for payment for the voice data transfer. Where the voice data transfer is completed, the data transfer information may include a total cost required for payment of the voice data transfer. However, where the voice data transfer is only initiated or is ongoing, the data transfer information may include and/or be updated with information used to determine a cost of the voice data transfer, such as a length of time of the voice data transfer, amount of data transferred, distance of data transferred, and other pricing variables used to determine a cost of the voice data transfer.

The payment provider may further receive a request by one or more of the users to assign responsibility for the voice data transfer to one of the users or split payment for the voice data transfer. The request may be initiated by the user(s) using their endpoint device. In various embodiments, the request may be initiated through an application executing on the endpoint device, such as a mobile device payment application associated with the payment provider. The application may also correspond to a voice data communication application having an option to request assignment of responsibility for payment of the voice data transfer by the payment provider. In other embodiments, the user may enter a code at initiation of or during the voice data transfer, such as through a keypad, voice command, or using another input device (e.g., Bluetooth headset). The payment provider may request that the user set preferences/requests for payment of the voice data transfer at initiation of or during the voice data transfer. However, in other embodiments, the option to assign responsibility for payment of the voice data transfer may be available at any time during the voice data transfer on entry of the request and/or selection of a request option presented within a graphical user interface of an application executing on the mobile device.

In various embodiments, one or more of the initiating user and/or the receiving user may establish preferences and/or settings that are used to determine whether the initiating user or the receiving user submits a request to allocate expenses to one or more of the users. For example, the initiating user may travel for 5 days, during which the initiating user may request that all voice data transfers are requested to be paid from the receiving user. Thus, the initiating user may establish a time frame during which the initiating user automatically submits a request for the receiving user to pay for received voice data transfers from the initiating user. In other embodiments, the preferences may include a minimum amount of available account resources (e.g., minutes, messages, data, etc.) to retain in an account of the initiating/receiving user, locations, time frames, and/or a maximum amount to bill/use of resources in an account, which may be limited by a time frame (e.g., 300 minutes in one month, 10 GB of data used in a week, etc.).

In other embodiments, the payment provider may determine whether to assign responsibility and allocate cost for the voice data transfer based on other information accessible about the initiating user and/or receiving user. For example, the payment provider may access a calendar and/or travel arrangements within an email account for the initiating user that includes data for the initiating users travel dates. Using this travel data, the payment provider may determine that the initiating user is traveling in a location (e.g., a separate country) where the initiating user may incur large costs for initiating a voice data transfer. Thus, the payment provider may allocate cost to the receiving user in such embodiments. Data used to determine a party responsible for payment of a voice data transfer may include location data, scheduling data, calendar data, travel data, messages, available data transfer account amounts (e.g., minutes, funds, messages, bandwidth amount, transferred data amount, etc.), biometrics, endpoint device capabilities, and/or endpoint device resources.

Thus, the request may be determined based on selection to submit the request prior to or during the voice data transfer, settings/preferences set by a user, and/or user information and/or device data. Once the request is received by the payment provider, the payment provider may alert the users/endpoints of the request where the users/endpoints may be unaware that a request is being made for the specific user/endpoint to assume partial or entire responsibility for payment of the voice data transfer. In this regard, the payment provider may display the request to one or more of the users/endpoint that all or partly allocation of payment is being made to. For example, where the receiving user would not normally pay for a voice data transfer, where the initiating user requests the receiving user to pay for the voice data transfer, the receiving user may receive a notification that payment is requested. The receiving user may accept or decline responsibility for payment. Where the request is declined, the payment provider may alert the initiating user of the refusal to accept responsibility for payment and/or end the voice data transfer. The initiating user may also accept that the receiving user has declined to pay for the voice data transfer, and may end the voice data transfer or choose to pay for the voice data transfer. However, where the user accepts to pay for the voice data transfer, the payment provider may then allocate responsibility for payment of the voice data transfer to the user(s) accepting responsibility for payment.

The payment provider may then determine a cost for the voice data transfer. The cost may be determined based on the rate plans for the voice data service providing resources for the voice data transfer, such as a cost in minutes, messaging capabilities, data transfer rates, etc. The cost may be determined by the payment provider using available rate information, or may be communicated to the payment provider by the service provider(s) for the initiating and/or receiving user(s). Thus, in various embodiments, the voice data transfer may also correspond to voice data or other data further transferred through a messaging service. For example, the users may exchange further messages and/or data through email, SMS, MMS, instant messaging, or other data transfer protocol. The data may be included during the voice data transfer, or may be linked to the voice data transfer (e.g., a transmittal of a data attachment made during or after a voice data transfer). Where the data transmitted is still attached to the voice data transfer, the payment provider may further assign responsibility for payment of the additional data to the user(s) accepting responsibility for the voice data transfer. Once a total cost is determined, the payment provider may assign responsibility to provide payment for this cost by the user(s) accepting responsibility for payment based on the request.

As the payment provider is separate from the voice data service providing the voice data transfer, the payment provider may otherwise provide payment for the voice data transfer than to change responsibility for payment from one account with the service provider to another account with the service provider. For example, the initiating user and the receiving user may possess payment accounts with the payment provider. The payment provider may debit the payment account of one of the users and credit the account of the other user for the cost of the voice data transfer. Such payment may be made in a currency value, or may be made in another value, such as minutes, messages, and/or data bandwidth with the user's service provider. Thus, the payment provider may provide the user initially responsible for the voice data transfer with sufficient payment to make the user whole again for service provider usage with the voice data service. Payment in plan usage (e.g., minutes, messages, data bandwidth, etc.) may be made into the payment account, and may be credited into the next bill from the service provider and/or used in purchasing additional pre-paid account usage by the user.

The payment provider may also debit the account of the user responsible for payment of the voice data transfer and provider payment to the service provider of the user initially responsible for the voice data transfer. In such embodiments, currency and/or plan usage amounts may be taken from the payment account of the party responsible for payment of the voice data transfer. The payment provider may then provide payment to the service provider to insure that the service provider does not debit the usage plan account of the party initially responsible for payment of the voice data transfer. The payment provider may provide an identifier for the user initially responsible for the voice data transfer (e.g., the initiating user) and/or the voice data transfer with the payment so that the payment is properly allocated. In other embodiments, the payment provider may request that the service provider of the user responsible for payment of the voice data transfer be debited the amount for the voice data transfer. Where the service provider of the user initially responsible for the voice data transfer also debits that user's account in order to pay for the voice data transfer, the payment provider may provide the payment received from the service provider of the user actually responsible for the voice data transfer to the other user. The payment may be credited to a payment account with the payment provider and/or to the service provider, as discussed herein.

Although the above is described to include voice data communications and transfers between two or more endpoints, in various embodiments, text and data transfers between two endpoints may similarly be performed. Thus, a payment provider may assist in allocation of payment for the data or text transfer in similar steps to above. In this regard, at initiation or during a text or voice data transfer (e.g., when a message or data transfer is sent or during a messaging session or data transfer session), the user initially responsible for the text/data transfer (e.g., the initiating user) may request that the other user accept partial or entire responsibility for payment for the text or data transfer. If the other user (e.g., the receiving user) accepts responsibility, the payment provider may provide for payment to a service provider as described herein. Moreover, if both endpoints are responsible for part payment or a payment to their service provider, one of the endpoints may request payment for their use of the service provider from the other endpoint, causing the other endpoint to provide two payments (e.g., the payment for both endpoints) to the service provider. In such embodiments, the payment provider may be used to provide both payments, as discussed herein.

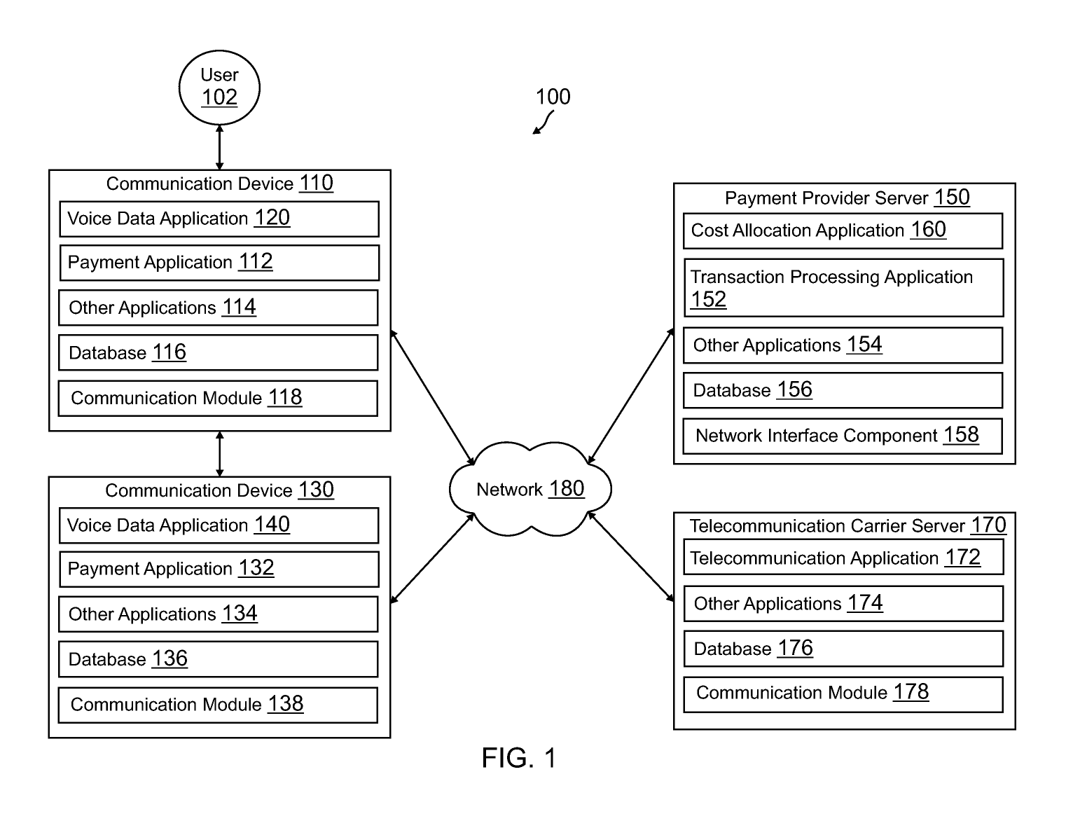

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user, a communication device 110, a communication device 130, a payment provider server 150, and a telecommunication carrier server 170 in communication over a network 180. The user may utilize communication device 110/130 to utilize the various features available for communication device 110/130, which may include processes and/or applications associated with a voice data transfer between communication device 110 and communication device 130. For example, communication device 110 may act as an initiating endpoint for a voice data transfer with communication device 130 as the receiving endpoint. Payment for the voice data transfer may initially be assigned to communication device 110. The user associated with communication device 110 may request that communication device 130 and/or the user associated with communication device 130 accept responsibility for payment of the voice data transfer. Payment provider server 150 may be used to communicate the request. Additionally, if the request is accepted, payment provider server 150 may be used to assign responsibility for payment to communication device 130/the user associated with communication device 130. Telecommunication carrier server 170 may be used to determine a cost of the voice data transfer, as well as complete payment and/or transfer payment. In other embodiment, communication device 130 may be the endpoint responsible for payment of the voice data transfer and allocation of responsibility for payment may similarly be moved the communication device 110 and/or the user associated with communication device 110.

Communication device 110, communication device 130, payment provider server 150, and telecommunication carrier server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 180.

Communication device 110/130 may be implemented as a communication device that may utilize appropriate hardware and software configured for wired and/or wireless communication with communication device 130, payment provider server 150, and/or telecommunication carrier server 170. For example, in one embodiment, communication device 110/130 may be implemented as a personal computer (PC), telephonic device, a smart phone, laptop/tablet computer, wristwatch with appropriate computer hardware resources, eyeglasses with appropriate computer hardware (e.g. GOGGLE GLASS ®), other type of wearable computing device, implantable communication devices, and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may function similarly.

One of communication device 110/130 may act as the communication device initiating a voice data transfer with the other one of communication device 110/130. With reference to the below figures, communication device 110 will be described as the endpoint initiating a voice data transfer with communication device 130. Moreover, communication device 110 will also be described as the endpoint initially responsible for payment of the voice data transfer. In this regard, communication device 110 may request that communication device 130 accept responsibility for the payment for the voice data transfer. Thus, communication device 130 is described as the endpoint assuming responsible for payment of the voice data transfer.

Communication device 110/130 of FIG. 1 contains a payment application 112/132, other applications 114/134, a database 116/136, and a communication module 118/138. Payment application 112/132, other applications 114/134, and other applications 114/134 may correspond to executable processes, procedures, and/or applications with associated hardware. In other embodiments, communication device 110/130 may include additional or different modules having specialized hardware and/or software as required.

Voice data application 120/140 may correspond to one or more processes to execute software modules and associated devices of communication device 110/130 to initiate and/or receive a voice data transfer, as well as request assignment of payment for the voice data transfer and/or accept responsibility for payment of the voice data transfer. In this regard, voice data application 120/140 may correspond to specialized hardware and/or software utilized by a user of communication device 110/130 to initiate a voice data transfer, such as a telephone voice call over a PSTN, a voice data transfer using VoIP, VoLTE, etc. or other voice data transfer service. Voice data application 120/140 may further allow for other data transfers, including mobile messaging (e.g., SMS, MMS, etc.), data messaging (e.g., email, instant messaging, etc.), and/or other types of data transfers. A first user of communication device 110 may use voice data application 120 to initiate a voice data transfer with communication device 130. A second user of communication device 130 may receive the request and establish a voice data transfer between communication device 110 and communication device 130. Telecommunication carrier server 170 may provide services necessary to perform the voice data transfer. Additionally, telecommunication carrier server 170 may further require payment for the voice data transfer. Initially, telecommunication carrier server 170 may assign responsibility to pay for the voice data transfer to one of communication device 110/130. For example, telecommunication carrier server 170 may require communication device 110 to pay for the voice data transfer that the first user has initiated with the second user using communication device 130 as the receiving endpoint. Thus, telecommunication carrier server 170 may require payment from the first user and/or debit a usage account for the first user/communication device 110 to provide payment for the voice data transfer.

However, the first user utilizing communication device 110 may request that the second user using communication device 110 accept responsibility to provide payment for the voice data transfer. Thus, although the first user initiated the voice data transfer and is initially responsible for the payment, the first user may request that the responsibility be assigned to the second user/communication device 130. In this regard, voice data application 120/140 may include options to request that the other endpoint of a voice data transfer accept partial or full responsibility for payment. The option may correspond to a selectable interface option within a graphical user interface of voice data application 120/140, a code entered during the voice data transfer (e.g., through a keypad, voice data entry, physical button of communication device 110/130 or associated device, etc.), or other entry. The request option may also be selected through payment application 112/132, as discussed herein. Once selected, the request may be communicated to payment provider server 150. In various embodiments, a request may not be required to be submitted at the start of or during a voice data transfer, and may be generated by payment provider server 150 based on stored information.

The request may further be communicated to the second user through communication device 130 by payment provider server 150. The request may alert the second user that the first user has requested that the second user accept responsibility for payment of the voice data transfer. The request may populate within voice data application 120/140 receiving the request. The request may include an option to accept responsibility for the payment, such as an “accept” or “decline” option. The request may further include a message from the user sending the request. In the aforementioned example, the second user may accept or decline responsibility for payment, which may alert the first user of the acceptance/refusal of acceptance. The alert of acceptance or refusal for payment may be displayed through voice data application 120/140. A total cost for payment for the voice data transfer may also be shown within voice data application 120/140 and/or payment application 112/132.

Payment application 112/132 may correspond to one or more processes to execute software modules and associated devices of communication device 110/130 to enter one or more payment instruments or other funding sources for storage in a digital wallet associated with a payment account (e.g., stored and/or serviced by payment provider server 150) and access the digital wallet and/or payment account for use. In this regard, payment application 112/132 may correspond to specialized hardware and/or software utilized by a user of communication device 110/130 that provides an interface to permit the user to enter input and other data for payment instruments, for example, through an input device (e.g., touch screen with a graphical user interface displayed by payment application 112/132, keypad/keyboard, mouse, etc.) and/or through a data capture device (e.g., scanner, camera, other optical device, etc.) In various embodiments, information for the payment account may also be stored to communication device 110/130 for use in an offline environment. The payment account accessible through payment application 112/132 may be used to initiate, receive, and/or process/complete transactions using services provided by payment provider server 150. The transactions may correspond to payments for voice data transfers. For example, the payment account may be used to provide payment for a voice data transfer using voice data application 120/140 that a user has accepted responsibility for payment.

Once entered, the payment instruments may be communicated to payment provider server 150 over network 180 by payment application 112/132 for establishment and/or maintenance/update of the payment account and/or entry into the digital wallet. Moreover, the user may further enter data for data usage accounts for the user to payment application 112/132 for storage with the payment account. However, in other embodiments, payment application 112/132 and/or payment provider server 150 may retrieve account information from one or more third party entities, such as telecommunication carrier server 170. The user of communication device 110/130 may also enter benefits to payment application 112/132. The benefits may correspond to one or more of rewards programs, rewards programs membership level, rewards program points, available items in at least one rewards program, cash-back amounts for the at least one rewards program, airline miles, promotional credit, promotional credit rates, promotional discount rate, merchant discounts, merchant discount rates, and merchant coupons.

Payment application 112/132 may be implemented as a user interface enabling the user to select and provide payment options for voice data transfers. In various embodiments, payment application 112/132 may include a general browser application configured to retrieve, present, and communicate information over the Internet (e.g., utilize resources on the World Wide Web) or a private network. For example, payment application 112/132 may provide a web browser, which may send and receive information over network 180, including retrieving website information (e.g., a website for payment provider server 150), presenting the website information to the user, and/or communicating information to the website, including payment information for payment through payment provider server 150. However, in other embodiments, payment application 112/132 may include a dedicated application of payment provider server 150 or other entity (e.g., a merchant), which may be configured to assist in processing purchase requests.

Payment application 112/132 may be utilized to select payment instrument(s) for use during in providing payment for voice data transfer. As discussed herein, payment application 112/132 may utilize user financial information, such as a credit card, bank account, or other financial account, as a payment instrument when providing payment information. Additionally, payment application 112/132 may utilize a user account with payment provider, such as payment provider server 150, as the payment instrument. The payment account may include data/service usage amounts with one or more telecommunication carrier services, such as telecommunication carrier server 170. In other embodiments, payment application 112/132 may utilize a data/service usage account with a telecommunication carrier service to request that payment provider server 150 use to provide payments, as discussed herein. Selection of a payment instrument may occur prior to, at, or after establishment of a user's responsibility to provide payment for a voice data transfer. Payment provider server 150 may then use the payment instrument during processing of payment for the voice data transfer, as discussed herein with respect to payment provider server 150.

As previously discussed, payment application 112/132 may also be used to assign responsibility for payment of a voice data transfer and/or accept payment for a voice data transfer. In this regard, payment application 112/132 may include an option similar to one discussed in reference to voice data transfer 120/140. The option may populate as a menu, toolbar, add-on, or other selectable option prior to, during, or after a voice data transfer. The option may also include entry of a code prior to, during, or after the voice data transfer that is detected by payment application 112/132. Moreover, payment application 112/132 may communicate received requests to pay for a voice data transfer to a user, such as a message and response option displayed within a graphical user interface and/or output through an audio output device. Payment application 112/132 may further be used to response to the request, including selection of options using an input device (e.g., keypad, keyboard, touchscreen, microphone, etc.). Payment application 112/132 may be utilized to view the results of payment for a voice data transfer.

Users may further use payment application 112/132 to enter preferences for assigning responsibility for payment of voice data transfers and/or initiating a request for another party to accept responsibility for payment of a voice data transfer. The preferences may be established with payment provider server 150 and may be used by payment provider server to determine whether to communicate a request to pay for a voice data transfer to the other endpoint during a voice data transfer, as discussed herein. For example, a first user of communication device 110 may establish that the first user is travel for 5 days and is requesting any other user that the first user contacts using voice data application 120 to pay for the voice data transfer. The preferences may be communication device payment provider server 150. Thus, a second user of communication device 130 may automatically receive the request from payment provider server 150 during the set time period. Other user preferences may include location preferences, scheduling preferences, account usage preferences, financial preferences, or other type of user limits and/or settings. Additionally, payment provider server 150 may automatically determine the request based on user, device, and/or account information, as discussed herein. In such embodiments, payment application 112/132 may collect and/or determine the user information, device information, and/or account information, which may be communicated to payment provider server 150.

One or more of the aforementioned features and/or processes of voice data application 120/140 may be included within payment application 112/132 or vice versa, for example, to provide their respective features within one application and/or application interface.

In various embodiments, communication device 110/130 includes other applications 114/134 as may be desired in particular embodiments to provide features to communication device 110/130. For example, other applications 114/134 may include security applications for implementing client-side security features, programmatic client applications for interfacing with appropriate application programming interfaces (APIs) over network 180, or other types of applications. Other applications 114/134 may also include email, texting, voice and IM applications that allow a user to send and receive emails, calls, texts, and other notifications through network 180. In various embodiments, other applications 114/134 may include financial applications, such as banking, online payments, money transfer, or other applications. Other applications 114/134 may also include other location detection applications, which may be used to determine a location for the user, such as a mapping, compass, and/or GPS application, which can include a specialized GPS receiver that obtains location information for communication device 110/130 and processes the location information to determine a location communication device 110/130 and the user. Other applications may include social networking applications, media viewing, and/or merchant applications.

Other applications 114/134 may also be associated with other devices, such as biometric devices and other types of accessible or connected devices. Other applications 114/134 may be utilized by other applications 114/134 to determine user data or other information, which may be communicated to payment provider server 150. Thus, other applications 114/134 may collect, capture, and/or otherwise determine user data and other information for the user, which may be used to determine where to allocate cost for a voice data transfer. The user's information may correspond to locations of the user, which may further be determined using a location determination system, such as a GPS module of communication device 110/130 and associated systems, calendaring/scheduling information, biometrics, etc. Other applications 114/134 may include device interfaces and other display modules that may receive input from the user and/or output information to the user. For example, other applications 114/134 may contain software programs, executable by a processor, including a graphical user interface (GUI) configured to provide an interface to the user. Other application may therefore use device of communication device 110/130, such as display devices, including GUI's capable of displaying information to users and other output devices, including speakers. Communication device 110/130 may include input devices, including touch screens. Communication device 110/130 may include a sensor or other component used to collect the current information associated with the user, such as an input device, a camera, a microphone, an accelerometer, a motion detector, an environmental sensor, and/or a biometric sensor.

Communication device 110/130 may further include database 116/136 stored to a transitory and/or non-transitory memory of communication device 110/130, which may store various applications and data and be utilized during execution of various modules of communication device 110/130. Thus, database 116/136 may include, for example, identifiers such as operating system registry entries, cookies associated with payment application 112/132 and/or other applications 114/134, identifiers associated with hardware of communication device 110/130, or other appropriate identifiers, such as identifiers used for payment/user/device authentication or identification, which may be communicated as identifying communication device 110/130 to payment provider server 150 and/or telecommunication carrier server 170. Database 116/136 may include information for a voice data transfer, such as identifiers for the endpoints, data usage, and/or cost. Additionally, database 116/136 may store a payment account information, telecommunication carrier usage account information, and/or associated information used by payment application 112/132, as well as data determined using other applications 114/134, such as user information communicated to payment provider server 150.

Communication device 110/130 includes at least one communication module 118/138 adapted to communicate with communication device 110/130, payment provider server 150, and/or telecommunication carrier server 170. In various embodiments, communication module 118/138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118/138 may communicate directly with nearby devices using short range communications, such as Bluetooth Low Energy, LTE Direct, WiFi, radio frequency, infrared, Bluetooth, and near field communications.

Payment provider server 150 may be maintained, for example, by an online payment service provider, which may provide payment services and/or processing for financial transactions on behalf of users. In this regard, payment provider server 150 includes one or more processing applications which may be configured to interact with communication device 110, telecommunication carrier server 170, and/or another device/server to facilitate payment for a voice data transfer, including establishment of payment accounts and assigning responsibility of payment for a voice data transfer to one or more users. In one example, payment provider server 150 may be provided by PAYPAL®, Inc. of San Jose, Calif., USA. However, in other embodiments, payment provider server 150 may be maintained by or include a credit provider, financial services provider, financial data provider, and/or other service provider, which may provide payment services to the user.

Payment provider server 150 of FIG. 1 includes a cost allocation application 160, a transaction processing application 152, other applications 154, a database 156, and a network interface component 158. Cost allocation application 160, transaction processing application 152, and other applications 154 may correspond to executable processes, procedures, and/or applications with associated hardware. In other embodiments, payment provider server 150 may include additional or different modules having specialized hardware and/or software as required.

Cost allocation application 160 may correspond to one or more processes to execute software modules and associated specialized hardware of payment provider server 150 to allocate cost of a voice data transfer to one or more participants and/or participant endpoints during the voice data transfer. In this regard, cost allocation application 160 may correspond to specialized hardware and/or software to receive and/or access data transfer information for a voice data transfer. The data transfer information may include data associated with the voice data transfer, including identifiers for users/endpoints of the voice data transfer (e.g., a name, user account identifier, device identifier, etc.). Additionally, the data transfer information may include a cost for the voice data transfer, or data used to determine a cost for the voice data transfer. For example, cost allocation application 160 may receive a currency fee for the voice data transfer, of may receive an amount of usage a voice data plan used for the voice data transfer and associated data transfers, including messaging and/or digital data transfers. However, in other embodiments, a length of the voice data transfer, locations of endpoints, amount of data used, or other information may be received, which may be used with accessible carrier charge rates for a carrier/service provider performing the voice data transfer. In various embodiments, the voice data transfer may be ongoing, and cost allocation application 160 may access or receive additional usage for the voice data transfer and associated data transfers as the transfers continue. Thus, cost allocation application 160 may access information from one or more service providers, such as telecommunication carrier providers.

Cost allocation application 160 may additionally receive or determine an initial endpoint assigned responsibility for the voice data transfer. In the example discussed above, a first user for communication device 110 may initiate the voice data transfer and initially be assigned responsibility for payment of the voice data transfer. However, the first user may request that a second user associated with communication device 130 instead accept responsibility for payment of the voice data transfer and cost is allocated to the second user/communication device 130. Thus, cost allocation application 160 may receive the request from communication device 110 and communicate the request to communication device 130. If the second user declines the request, cost allocation application 160 may alert the first user through communication device 110. Where expense for the voice data transfer is still required, cost allocation application 160 may allow the service provider for the voice data transfer (e.g., telecommunication carrier server 170) to charge the first user's usage account and/or may provide payment for the voice data transfer from a payment instrument for the first user.

However, where the second user accepts responsibility to provide payment for the voice data transfer between communication device 110 and communication device 130, cost allocation application 160 may then allocate cost to the second user and/or communication device 130. Payment for the voice data transfer may then be effectuate to the first user/cornmunication device 110 and/or the service provider performing the voice data transfer (e.g., telecommunication carrier server 170) using a payment account and/or usage account for the second user/communication device 130. For example, in one embodiment, cost allocation application 160 may use a payment account for the second user and/or communication device 130 to provide a payment to the first user, which may be provided in another payment account for the first user. However, in other embodiments, cost allocation application 160 may provide payment in the form of usage amounts for the voice data transfer, such as minutes, messages, and/or bandwidth. The currency payment and/or usage amounts may be provided in a payment account so that the first user may use the payment in the currency and/or usage amounts for a usage bill from telecommunication carrier server 170, further prepaid accounts for a usage account, and/or in additional voice data transfers.

However, in other embodiments, cost allocation application 160 may request that the service provider (e.g., telecommunication carrier server 170) for a usage account of the second user used during the voice data transfer be reduced/debited the amount for the voice data transfer. Cost allocation application 160 may receive the debit and may provide the debit to the other service provider in the form of a credit, such as a currency payment and/or usage amount credit. Where the debit and/or credit occur with the same service provider, cost allocation application may not be required to receive the debit and credit the same service provider, and may perform the transaction by alerting the service provider (e.g., telecommunication carrier server 170) to debit/credit the accounts within their system.

Additionally, cost allocation application 160 may also instead pay the service providers using currency and/or held usage amounts instead of requesting that the service provider debit and credit accounts accordingly. In such embodiments, cost allocation application 160 may request payment from one service provider and may credit another service provider. In the above embodiments, cost allocation application 160 may further provide services for allocation of cost at a fee amount (e.g., straight fee, percentage cost, enrollment in a service, etc.), which may be taken from the payment account of one or more of the users and/or usage accounts with one or more service providers. Although cost is described as allocated between two users/endpoints in the above description, additional users/endpoints may further be used and/or allocated of expense for the voice data transfer, for example, in embodiments using conference calling. Moreover, the entire cost may not be shifted solely to one party, and instead partial payment may be made by one or more parties pursuant to an amount set by the initially responsible party. For example, the first user may request that the second user pay 50%, $5, use 10 minutes of a usage account, or otherwise accept partial responsibility.

Transaction processing application 152 may correspond to one or more processes to execute software modules and associated specialized hardware of payment provider server 150 to establish, maintain, and provide a payment account to a user based on entered payment instruments, usage accounts with a service provider, or other funding sources by the user. In this regard, transaction processing application 152 may correspond to specialized hardware and/or software to receive information requesting establishment of the payment account. The information may include user personal and/or financial information. Additionally the information may include a login, account name, password, PIN, or other account creation information. The user may provide a name, address, social security number, or other personal information necessary to establish the account and/or effectuate payments through the account, for example, payment for a voice data transfer. The user may also provide information for the payment instruments, for example, through one or more input devices of communication device 110. Once entered, the payment account may be established. Transaction processing application 152 may further allow the user to service and maintain the digital wallet, for example, by adding and removing payment instruments. The funding instruments may include credit cards, debit cards, bank accounts, funds in a brokerage account, electronic payment accounts, merchant credit accounts, gift cards, coupon codes, discount codes, rewards accounts, and available cash-back from at least one rewards account. Additionally, the funding instruments may include a usage account with a service provider, such as a voice data plan with telecommunication carrier server 170. In various embodiments, the payment account may receive funds from one or more other sources, such as another endpoint for a voice data transfer. The funds may include payments for a voice data transfer. The funds may be currency, or may be usage account amounts, such as minutes, messages, and/or data bandwidth usage. Thus, transaction processing application 152 may be used to send and receive payments for a voice data transfer. The payments may be sent and/or received with another user, a service provider, or with an account for payment provider server 150 that effectuates payments to users and/or service providers for voice data transfers.

In various embodiments, payment provider server 150 includes other applications 154 as may be desired in particular embodiments to provide features to payment provider server 134. For example, other applications 154 may include security applications for implementing server-side security features, programmatic client applications for interfacing with appropriate application programming interfaces (APIs) over network 180, or other types of applications. Other applications 154 may contain software programs, executable by a processor, including a graphical user interface (GUI), configured to provide an interface to the user when accessing payment provider server 134, where the user or other users may interact with the GUI to more easily view and communicate information. In various embodiments, other applications 154 may include connection and/or communication applications, which may be utilized to communicate information to over network 180.

Additionally, payment provider server 150 includes database 156. As previously discussed, the user and/or the merchant corresponding to telecommunication carrier server 170 may establish one or more digital wallets and/or payment accounts with payment provider server 150. Digital wallets and/or payment accounts in database 156 may include user information, such as name, address, birth date, payment instruments/funding sources, additional user financial information, user preferences, and/or other desired user data. The payment accounts may further include information for voice data transfers and/or usage accounts for voice data transfers. Users may link to their respective digital wallets and/or payment accounts through an account, user, merchant, and/or device identifier. Thus, when an identifier is transmitted to payment provider server 150, e.g. from communication device 110/130, one or more digital wallets and/or payment accounts belonging to the users may be found. Database 156 may also store the user preferences for the user, as well as information used to determine the user preferences, such as information used to automatically request another party assume responsibility to pay for a voice data transfer.

In various embodiments, payment provider server 150 includes at least one network interface component 158 adapted to communicate communication device 110, communication device 130, and/or telecommunication carrier server 170 over network 180. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Telecommunication carrier server 170 may be maintained, for example, by a service provider that offers resources, infrastructure, devices, and/or other technology to effectuate voice data transfers between users. In this regard, telecommunication carrier server 170 may correspond to a PSTN provider, or may correspond to Internet Service Providers, communication applications, and/or other types of service providers. Telecommunication carrier server 170 includes one or more processing applications which may be configured to interact with communication device 110, communication device 130, and/or payment provider server 150 to engage in a voice data transfer and receive payment for the voice data transfer, including allocating payment to another party during the voice data transfer based upon an agreement between the participants of the voice data transfer. Although a server is shown, the server may be managed or controlled by any suitable processing device. Although only a single service provider is shown, a plurality of service providers may function similarly.

Telecommunication carrier server 170 of FIG. 1 contains a telecommunication application 172, other applications 174, a database 176, and a communication module 178. Telecommunication application 172 and other applications 174 may correspond to processes, procedures, and/or applications executable by a hardware processor, for example, a software program. In other embodiments, telecommunication carrier server 170 may include additional or different modules having specialized hardware and/or software as required.

Telecommunication application 172 may correspond to one or more processes to execute software modules and associated specialized hardware of telecommunication carrier server 170 to provide data transfer services, including voice data transfers and usage account services. In this regard, telecommunication application 172 may correspond to specialized hardware and/or software of telecommunication carrier server 170 to establish a usage account for one or more users, for example, a usage account for communication device 110/130. The usage account may correspond to an account allowing a user to perform data transfers with other users, such as voice calls, messaging, and/or other types of data transfers. The usage account may be pre-paid and include a number of minutes, messages, and/or bandwidth usage allowance. However, the usage account may include a set monthly amount with allowance for overages and be billable monthly. The usage account may also correspond to a straight bill for data usage within a time period and/or one use. The usage account may be associated with a user and/or a communication device. Thus, the usage account may be used with more than one user using a single communication device (e.g., a telephone in a family household) or may be used with multiple communication devices (e.g., a family plan for multiple mobile phones).

Telecommunication application 172 may further receive requests to establish a voice data transfer and establish the voice data transfer. Telecommunication application 172 may “bill” or assign responsibility for payment for the voice data transfer to one or more participants in the voice data transfer based on rearranged rules and/or policies. For example, with respect to the scenario discussed above, a first user of communication device 110 may initiate a voice data transfer with a second user of communication device 130. The first user may be required to pay for the voice data transfer, which may reduce an amount within a usage plan or initiate a bill to the first user. As discussed herein, payment provider server 150 may be used to change responsibility of payment for the voice data transfer between the participants of the voice data transfer. Additionally, telecommunication application 172 may receive payments for a voice data transfer in order to effectuate the change or payment responsibility, and may also adjust usage account amounts based on the change in payment responsibility.

In various embodiments, payment provider server 150 includes other applications 154 as may be desired in particular embodiments to provide features to payment provider server 134. For example, other applications 154 may include security applications for implementing server-side security features, programmatic client applications for interfacing with appropriate application programming interfaces (APIs) over network 180, or other types of applications. Other applications 154 may contain software programs, executable by a processor, including a graphical user interface (GUI), configured to provide an interface to the user when accessing payment provider server 134, where the user or other users may interact with the GUI to more easily view and communicate information. In various embodiments, other applications 154 may include connection and/or communication applications, which may be utilized to communicate information over network 180.

Telecommunication carrier server 170 may further include database 176 which may include, for example, identifiers such as operating system registry entries, cookies associated with telecommunication application 172 and/or other applications 174, identifiers associated with hardware of telecommunication carrier server 170, or other appropriate identifiers, such as identifiers used for payment/user/device authentication or identification. Database 176 may further include usage account for voice data transfers. Additionally, a voice data information for a voice data transfer may be stored to database 176, which may include identifiers for one or more endpoints and/or users for the voice data transfer and a cost for the voice data transfer.

Telecommunication carrier server 170 includes at least one communication module 178 adapted to communicate with communication device 110, communication device 130, and/or payment provider server 150. In various embodiments, communication module 178 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Network 180 may be implemented as a single network or a combination of multiple networks. For example, in various embodiments, network 180 may include the Internet or one or more intranets, landline networks, wireless networks, and/or other appropriate types of networks. Thus, network 180 may correspond to small scale communication networks, such as a private or local area network, or a larger scale network, such as a wide area network or the Internet, accessible by the various components of system 100.

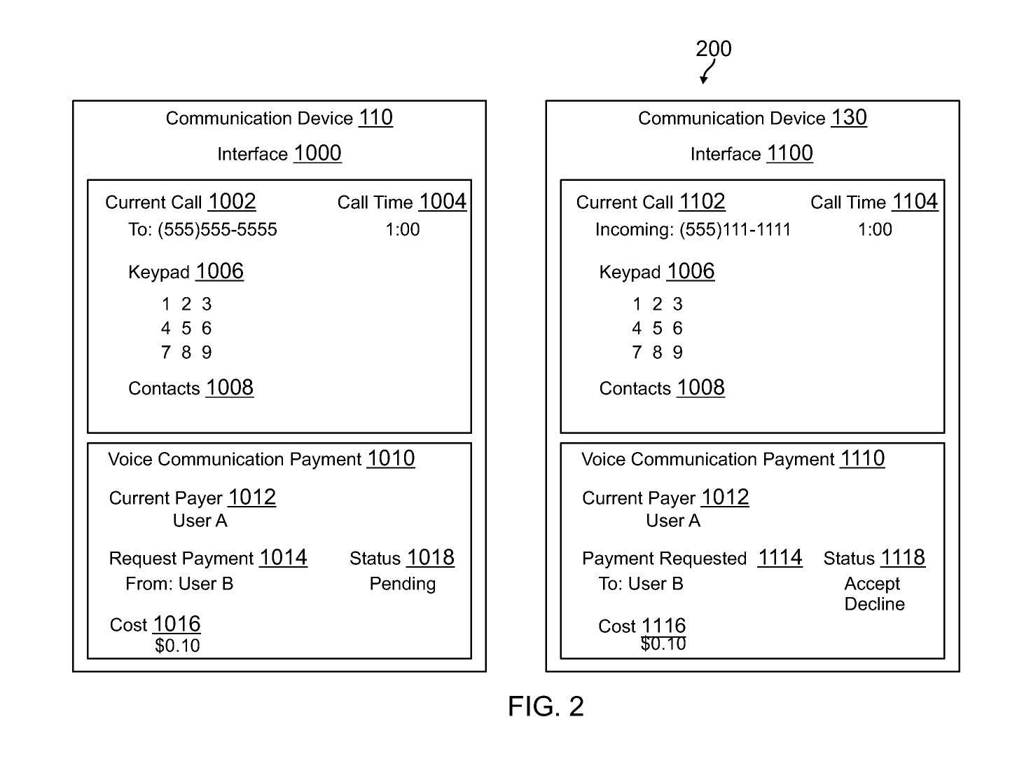

FIG. 2 is exemplary interfaces of a voice data endpoint during a voice data transfer and used for allocation of expenses, according to an embodiment. Environment 200 includes communication device 110 and communication device 130 corresponding generally to the devices described in reference to environment 100 of FIG. 1. Moreover, Communication device 110 displays an interface 1000 and communication device 130 displays an interface 1100. Interface 1000 and interface 1100 may correspond generally to graphical user interfaces displayed on an output display device, which may display information processed by payment application 112/132 and/or voice data application 120/140.

Thus, interface 1000 of communication device 110 displays an outgoing voice data transfer with communication device 130, which may be established based on a request to initiate and engage in a voice data transfer. Communication device 110 therefore acts as the initiating endpoint for the voice data transfer, where communication device 130 is the receiving endpoint for the voice data transfer. In this regard, a user A (not shown) of communication device 110 may initiate the voice data transfer using displayable information on interface 1000, as well as an input device of communication device 110 (e.g., a mouse, keypad, keyboard, touchscreen interface, etc.). Interface 1000 includes a current call 1002 to communication device 130, which may display the identifier (e.g., phone number, messenger name, etc.) for communication device 130 and/or a second user associated with communication device 130. Current call 1002 may be established using a keypad 1006 and/or contacts 1008. Additionally, interface 1000 may display additional information to a user for a voice data transfer, including call time 1004. In various embodiments, data transferred and/or messages consumed may also be displayed.

In order to request that the second user for communication device 130 accept responsibility to pay for a voice data transfer, the user A of communication device 110 may utilize voice communication payment 1010 within interface 1000. Voice communication payment 1010 may correspond to a part of a graphical user interface allowing the user A to select options for payment of a voice data transfer. Thus, voice communication payment 1010 includes a current payer 1012, which is noted as user A. However, user A may select to request payment 1014, which user B may be entered by user A and/or populated during the voice data transfer. For example, user A may utilize keypad 1006 and/or another input device to enter in request payment 1014. User A may further view a status 1018 for request payment 1014, as well as a cost 1016 for the voice data transfer.

Interface 1100 of communication device 130 may display the incoming the voice data transfer established based on acceptance of a request to initiate and engage in a voice data transfer. Thus, interface 1100 displays similar information for the voice data transfer as interface 1000 of communication device 110. In this regard, interface 1100 of communication device 130 displays a current call 1102 having an identifier from user A and/or communication device 110, as well as a call time 1104, a keypad 1006 for entry of input, and contacts 1008.

In order to accept payment for the voice data request, interface 1100 further includes voice communication payment 1110, which may display an incoming request to accept responsibility for the cost of current call 1102. Voice communication payment 1110 includes a current payer 1012, which displays that user A is still currently allocated responsibility to pay for current call 1102. However, using voice communication payment 1110, user B may view a payment requested 1114, which displays that payment is requested to user B. Under status 1118, user B may select an option to accept or decline, which may be selected based on input, for example, through keypad 1006 or another input mechanism, such as a touch screen input. User B may further view cost 1116 for acceptance of payment for current call 1102. In further embodiments, one or more of cost 1016 and 1116 may further include a fee for use of a payment provider's service in changing allocation of cost 1016/1116.

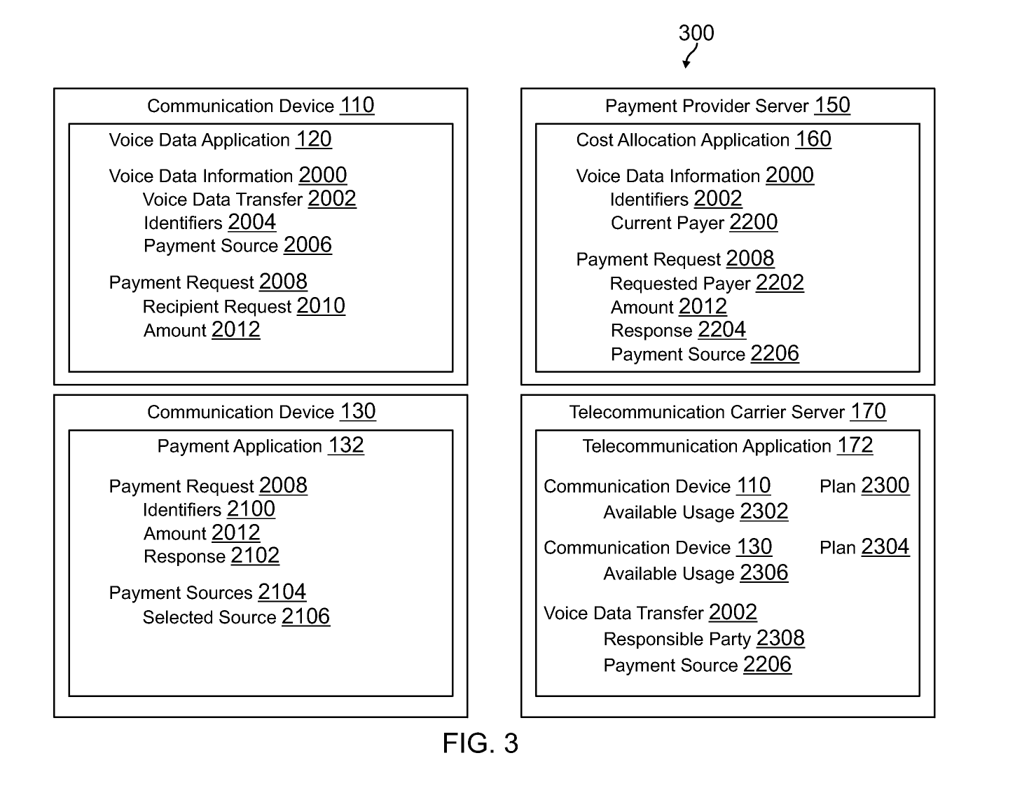

FIG. 3 is an exemplary system environment showing voice data endpoints during a voice data transfer and additional service providers for initiation of the voice data transfer and allocation of expenses, according to an embodiment. FIG. 3 includes communication device 110, communication device 130, payment provider server 150, and telecommunication carrier server 170 all discussed in reference to environment 100 of FIG. 1.

Communication device 110 executes voice data application 120 corresponding generally to the specialized hardware and/or software modules and processes described in reference to FIG. 1. In this regard, voice data application 120 include data used to establish a voice data transfer and transmit a request for another endpoint (e.g., communication device 130) to accept responsibility for payment of the voice data transfer. Thus, voice data application 120 includes voice data information 2000, which may include a voice data transfer 2002 with another endpoint, such as communication device 130. Additionally, voice data information 2000 includes identifiers 2004 for the endpoints, as well as a currently assigned payment source 2006 for voice data transfer 2002. In order to communicate the request to accept responsibility for payment of voice data transfer 2002 to communication device 110, voice data application 120 further includes a payment request 2008, which may include a recipient request 2010 to communication device 130 and an amount 2012 for payment request 2008 (e.g., all of part of the cost for voice data transfer 2002).

Communication device 130 executes payment application 132 corresponding generally to the specialized hardware and/or software modules and processes described in reference to FIG. 1. In this regard, payment application 132 may execute during voice data transfer 2002 and be used to accept responsibility for payment of voice data transfer 2002 by a user of communication device 130 and provide a payment instrument for the payment. Thus, payment application 132 includes a payment request 2008, which include identifiers 2100 allowing for identification of the endpoints and/or users within voice data transfer 2002. Identifiers 2100 may be used to also identify voice data transfer 2002 as well as payment accounts and/or usage accounts for voice data transfers. Payment request further includes amount 2012, and may include a response 2102 by the user for communication device 130. Payment application 132 may further include data for payment sources 2014 that may be used on acceptance of payment request 2008, such as a selected source 2106 (e.g., a payment account, usage account with a service provider, etc.).

Payment provider server 150 executes cost allocation application 160 corresponding generally to the specialized hardware and/or software modules and processes described in reference to FIG. 1. In this regard, cost allocation application 160 may be used to allocate costs for voice data transfer 2002 between the endpoints of communication device 110 and communication device 130. Thus, cost allocation application 160 may receive voice data information 2000 for voice data transfer 2002 between communication device 110 and communication device 130. Voice data information 2000 includes identifiers 2002 allowing payment provider server 150 to identify communication device 110 and communication device 130. Further, voice data information 2000 includes a current payer 2200 for voice data transfer 2002. However, cost allocation application 160 may further receive payment request 2008 from one or more of communication device 110 and communication device 130. Payment request may be communicated by payment provider server 150 to communication device 130, and response 2102 may further be sent back to communication device 110. Thus, payment request 2008 within cost allocation application 160 includes a requested payer 2202, as well as amount 2012. A response 2204 may be determined using response 2102 from communication device 130, which may be transmitted to communication device 110 to alert the user of communication device 110 of payment status. Additionally, cost allocation application 160 may determine a payment source 2206 based on response 2204, such as a payment account/usage account for the user associated with communication device 130 where response 2204 indicates acceptance of payment responsibility. However, where the user of communication device 130 declines payment responsibility, payment source 2206 may be associated with communication device 110, and may utilize the payment account and/or usage account for the user associated with communication device 110.

Payment provider server 150 may interact with telecommunication carrier server 170 to effectuate payment for voice data transfer 2002. Telecommunication carrier 170 executes telecommunication application 172 corresponding generally to the specialized hardware and/or software modules and processes described in reference to FIG. 1. In this regard, telecommunication application 172 may be used to establish voice data transfers and provide payment for use of the services associated with the voice data transfers. Thus, telecommunication application 172 includes information identifying communication device 110 and communication device 130. As shown in environment 300, communication device 110 is associated with a plan 2300, which further includes available usage 2302. Similarly, communication device 130 is associated with a plan 2304, which further includes available usage 2306. Telecommunication application 172 may further include information for voice data transfer 2002, which may include a responsible party 2308, as well as a payment source 2206, which may be provided by payment provider server 150 in certain embodiments. Additionally, available usage 2302 and/or available usage 2306 may further be used to determine payment request 2008 automatically, such as if available usage 2302 for communication device 110 is running low or empty. Payment provider server 150 may automatically determine payment request 2008 using this information, as well as setting and parameters for automatic determination of a payment request (e.g., location preferences, travel plans, etc.).

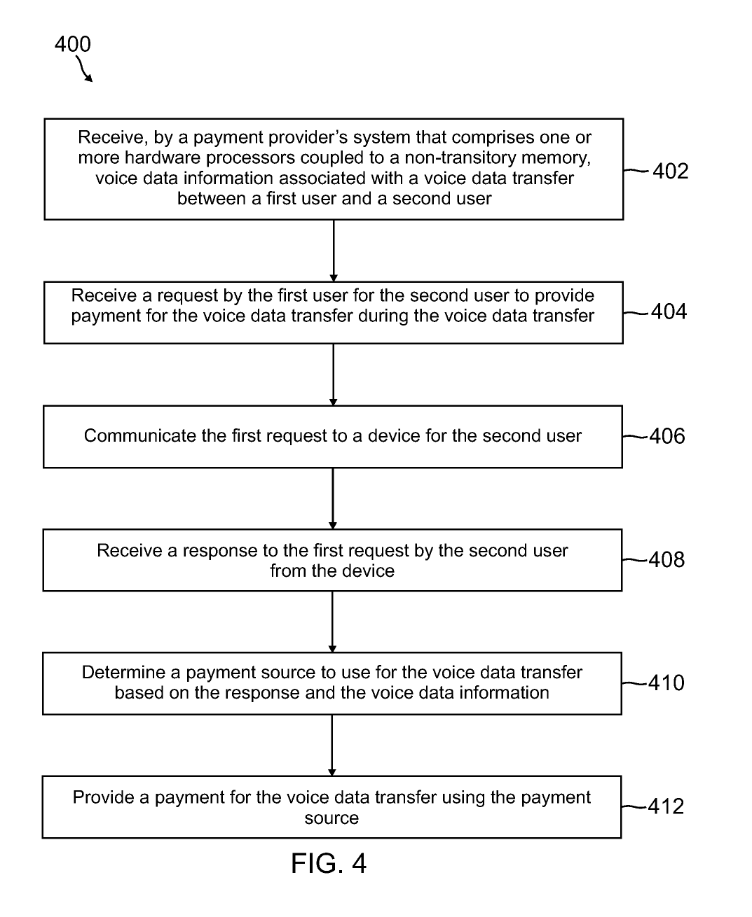

FIG. 4 is a flowchart of an exemplary process for allocating expense of voice data transfers between participants, according to an embodiment. Note that one or more steps, processes, and methods described herein may be omitted, performed in a different sequence, or combined as desired or appropriate.

At step 402, data transfer information associated with a voice data transfer between a first user and a second user is received, by a payment provider's system that comprises one or more hardware processors coupled to a non-transitory memory. The first user may initiate the voice data transfer with the second user through a device for the first user connecting with a device for the second user. The voice data transfer may comprise one of a telephone call using a Public Switched Telephone Network (PSTN), a voice of IP (VoIP) data transfer, a mobile VoIP data transfer, and a voice over LTE (VoLTE) data transfer.

A request by the first user for the second user to provide payment for the voice data transfer during the voice data transfer is received, at step 404. In various embodiments, at initiation of the voice data transfer, the first user assumes responsibility for the payment for the voice data transfer. Thus, the request comprises a payment request that assigns responsibility for the payment to the second user. The request may be submitted through mobile application for payment provider executing on a first user device for the first user. The request may also or instead be submitted through a code entered during the voice data transfer.

At step 406, the request is communicated to a device for the second user. Thus, at step 408, a response to the request by the second user is received from the device. The response may comprise an acceptance of responsibility for the payment for the voice data transfer. Thus, a payment source is associated with the second user may be determined and used for payment of the voice data transfer. However, in pother embodiments, the response comprises a rejection of responsibility for the payment for the voice data transfer. Thus, a payment source for payment for the voice data transfer instead will be associated with the first user.

A payment source to use is determined, at step 410, based on the response and the data transfer information. At step 412, a payment for the voice data transfer is provided using the payment source. Where the second user assumes responsibility for the payment, the payment may be provided using a second user payment account for the second user with the payment provider. The payment may be provided to one of a telecommunications carrier and a first user payment account for the first user with the payment provider. The payment source may comprise an account for one of the first user and the second user. The payment source may be determined based on at least one of a lowest cost for the voice data transfer using the account for one of the first user and the second user and available usage allowances in the account for one of the first user and the second user. Thus, the payment provider provides the payment to at least one a telecommunications carrier for the first user and the second user and a receiving account for one of the first user and the second user.

The payment provider may be established to provide payments to at least one telecommunications carrier for the first user and the second user, wherein the payment source is associated with only one of the first user and the second user, and wherein the payment provider determines the payment source based on information for the first user and the second user. In such embodiments, the information may comprise at least one of schedules, locations, available funds, minutes in a telecommunications carrier plan for the first user and the second user, data in the telecommunications carrier plan, the telecommunications carrier plans' overage charges, the telecommunications carrier plans' roaming charges, the telecommunications carrier plans' distance charges, per month usage of the telecommunications carrier plans by the first user and the second user, and available telecommunications carrier plans' usage amounts. In other embodiments, the first user may set usage parameters associated with usage of a telecommunications carrier plan of the first user, and wherein the usage parameters are used to determine the information. Thus, the request is generated by the payment provider based on usage parameters set by the first user.

The payment may be provided using at least one of available telephone call minutes, available data usage, and available messaging usage in a plan of the second user with a telecommunications carrier subscribed to by the second user. In such embodiments, the at least one of the available telephone call minutes, the available data usage, and the available messaging usage is deducted from the plan of the second user and provided to an account associated with one of the payment provider and the first user.

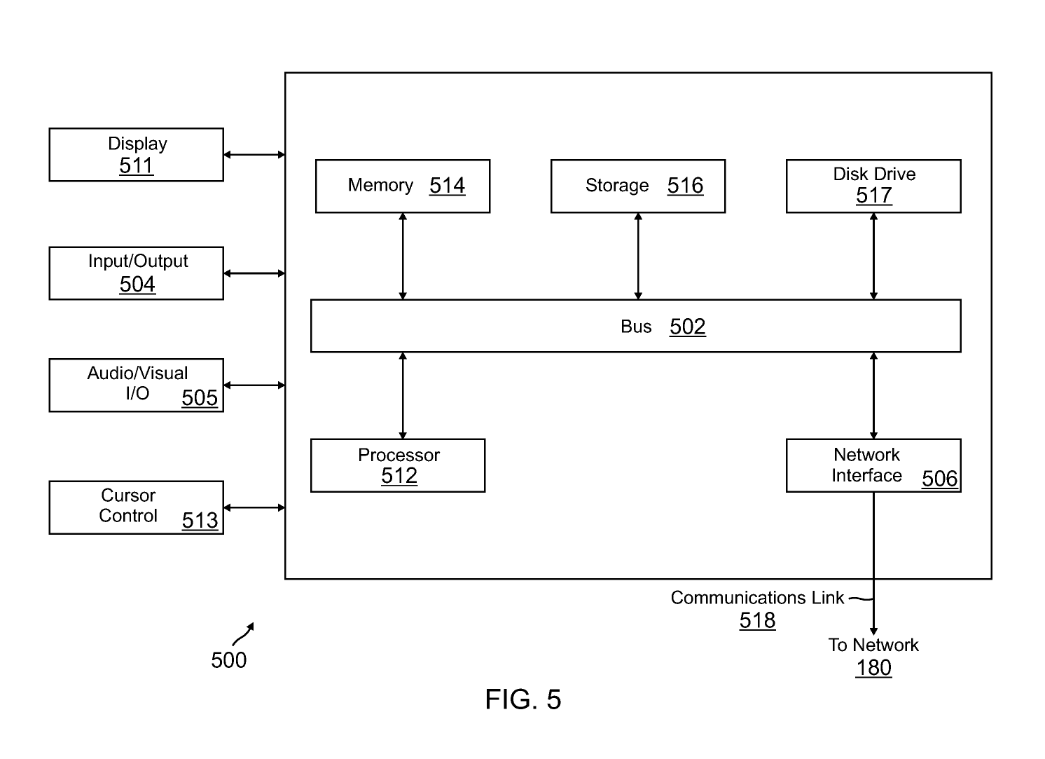

FIG. 5 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 180. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system, comprising:
a non-transitory memory; and
one or more hardware processors coupled to the non-transitory memory and configured to read instructions from the non-transitory memory to cause the system to perform operations comprising:
detecting an occurrence of an event associated with a payment for a data transfer between a first device and one or more other devices;
in response to the detecting the occurrence of the event, determining a user for allocation of the payment by comparing the event to a database of events and corresponding users;
determining a payment source to use for the payment based on information received from a second device corresponding to the user;
providing a payment for the data transfer using the determined payment source;
determining that an amount of time associated with the event has been exceeded; and
in response to determining that an amount of time associated with the event has been exceeded, reverting back to an original payment source, wherein the original payment source is different that the determined payment source.

2. The system of claim 1, wherein the detecting the occurrence of the event comprises:
determining that a user associated with the first device is in a location where a cost associated with an amount of data transfer exceeds a threshold amount.

3. The system of claim 2, wherein the determining that the user associated with the first device is in the location comprises referencing a calendar associated with the user and determining a location associated with a travel plan associated with a certain time period.

4. The system of claim 1, wherein, in response to the detecting the occurrence of the event, further determining a second user for allocation of the payment by comparing the event to a database of events and corresponding users.

5. The system of claim 4, wherein the determining the payment source to use for the payment is further based on information received from a third device corresponding to the second user.

6. The system of claim 1, wherein the payment is provided using one or more of available telephone call minutes, available data usage, and available messaging usage in a plan of the user.

7. The system of claim 6, wherein the one or more of the available telephone call minutes, the available data usage, and the available messaging usage is deducted from the plan of the user and provided to an account associated with the first device.

8. The system of claim 1, the operations further comprising in response to the determining the payment source, transmitting a request to the second device requesting a confirmation as to acceptance of responsibility for payment for the data transfer.

9. The system of claim 8, wherein the request is submitted through a code entered during the data transfer.

10. The system of claim 8, wherein the providing the payment for the data transfer is in response to receiving, from the second device, confirmation that responsibility for the payment for the data transfer has been accepted.

11. The system of claim 1, wherein the detecting an occurrence is based on an element selected from a group consisting of schedules, locations, available funds, minutes in a telecommunications carrier plan, data in the telecommunications carrier plan, the telecommunications carrier plan's overage charges, the telecommunications carrier plan's roaming charges, the telecommunications carrier plan's distance charges, per month usage of the telecommunications carrier plan, and available telecommunications carrier plan's usage amounts.

12. The system of claim 1, wherein the detecting an occurrence is based on usage parameters associated with a telecommunication plan corresponding to the first device.

13. The system of claim 1, wherein the user is allocated responsibility for a part of the payment.

14. The system of claim 1, wherein the data transfer is an element selected from a group consisting of a telephone call using a Public Switched Telephone Network (PSTN), a voice of IP (VoIP) data transfer, a mobile VoIP data transfer, and a voice over LTE (VoLTE) data transfer.

15. A method comprising:
detecting an occurrence of an event associated with a payment for a data transfer between a first device and one or more other devices;
in response to detecting an occurrence of the event, determining a user for allocation of the payment by comparing the event to a database of events and corresponding users;
determining a payment source to use for the payment based on information received from a second device corresponding to the user; and
providing a payment for the data transfer using the determined payment source.

16. The method of claim 15, wherein the detecting the occurrence of the event comprises:
determining that a user associated with the first device is in a location where a cost associated with an amount of data transfer exceeds a threshold amount.

17. The method of claim 15, wherein the determining that the user associated with the first device is in the location comprises referencing a calendar associated with the user and determining a location associated with a travel plan associated with a certain time period.

18. The method of claim 15, wherein, in response to the detecting the occurrence of the event, further determining a second user for allocation of the payment by comparing the event to a database of events and corresponding users.

19. The method of claim 15, wherein the payment source comprises one of a payment account with a payment provider, a usage plan with a telecommunications carrier, and a prepaid telecommunications account.

20. A non-transitory machine-readable medium having stored thereon machine-readable instructions executable to cause a machine to perform operations comprising:
detecting an occurrence of an event associated with a payment for a data transfer between a first device and one or more other devices;
in response to detecting an occurrence of the event, determining a user for allocation of the payment by comparing the event to a database of events and corresponding users;
determining a payment source to use for the payment based on information received from a second device corresponding to the user; and
providing a payment for the data transfer using the determined payment source.
